(19) United States
(12) Patent Application Publication
(10) Pub. No.: US 2006/0016836 A1
(43) Pub. Date: Jan. 26, 2006

(54) Shaped spouts for flip-top closures

(76) Inventor: Rick Gaiser, Burlington, WI (US)

Correspondence Address: KNOBLE YOSHIDA & DUNLEAVY, LLC;Suite 1350, Eight Penn Center, 1628 John F. Kennedy Blvd., Philadelphia, PA, 19103, US

(21) Appl. No.: 10/894,903

(22) Filed: Jul. 20, 2004

(51) Int. Cl. B65D 47/00; B67D 3/00

(52) U.S. Cl. 222/556

(57) ABSTRACT

A closure for a container includes a main body portion that is constructed and arranged to be secured to a container. The main body portion has an upper deck that defines an upper surface and a dispensing spout that projects upwardly from the upper surface. A dispensing orifice is defined in the dispensing spout for dispensing liquid material from the container when the closure is open. The dispensing spout advantageously constructed and arranged so as to have a noncircular shape when viewed in plan. This noncircular shape could be for aesthetic and marketing purposes, for functional purposes, or both. A lid member is hingedly mounted to the main body portion and includes a plug member that is shaped and sized to selectively plug the dispensing orifice when the lid member is in the closed position.

### BACKGROUND OF THE INVENTION

1. Field of the Invention

This invention generally relates to a flip-top type dispensing closure of the type that has a hinged reclosable lid that may be swung open to reveal a dispensing orifice for the closure. More specifically, this invention relates to dispensing spouts for such closures.

2. Description of the Related Technology

Various beverages, foods, medicines and the like are delivered to the public in bottles or other containers that are provided with resealable closures. Such closures provide a benefit to the consumer in that the containers can be tightly sealed and resealed after opening, which prolongs the shelf life of the product and maintains freshness. One popular type of resealable closure is the flip-top closure that typically includes a main body portion that is adapted to be secured to a container and a lid member that is hingedly mounted to the main body portion. An orifice is typically defined in the main body portion and a mating plug is provided on the lid member for sealing the orifice when the closure is in the closed position.

When dispensing viscous liquid materials such as dishwasher detergent, recurring issues to consumers and design professionals in this area of technology include deposition of dried or caked product around the dispensing orifice and pourability of the product as it is pushed out of the closure by squeezing the container. In addition, aesthetics and potential brand identity play an important role in closure technology.

### SUMMARY OF THE INVENTION

It is an object of the invention to provide an improved flip-top type closure for a container that improves pourability and control of the material as it is being dispensed from the closure, and that provides the potential for improved aesthetics and an element of brand identity for the product manufacturer.

In order to achieve the above and other objects of the invention, a closure for a container that is constructed according to a first aspect of the invention includes a main body portion that is constructed and arranged to be secured to a container, the main body portion having an upper deck portion defining an upper surface and a dispensing spout projecting upwardly from the upper surface, the main body portion further having a dispensing orifice defined in the dispensing spout, and wherein the dispensing spout is constructed and arranged to have a noncircular shape when viewed in plan; a lid portion that is hingedly mounted to the main body portion, the lid portion having a plug member that is shaped and sized to selectively plug the dispensing orifice, the lid portion further being movable between a first, open position wherein material may be dispensed from the container through the dispensing orifice and a second, closed position wherein the orifice is blocked by said plug member.

A closure for a container according to a second aspect of the invention includes a main body portion that is constructed and arranged to be secured to a container, the main body portion having an upper deck portion defining an upper surface and a dispensing spout projecting upwardly from the upper surface, the main body portion further having a dispensing orifice defined in the dispensing spout, the dispensing spout further having a raised peripheral rim and at least one downwardly sloping surface between the peripheral rim and the dispensing orifice; a lid portion that is hingedly mounted to the main body portion, the lid portion having a plug member that is shaped and sized to selectively plug the dispensing orifice, the lid portion further being movable between a first, open position wherein material may be dispensed from the container through the dispensing orifice and a second, closed position wherein the orifice is blocked by the plug member.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a plan view of a closure that is constructed according to a preferred embodiment of the invention;

FIG. 2 is a cross-sectional view taken along lines 2-2 in FIG. 1;

FIG. 3 is a cross-sectional view similar to that shown in FIG. 2, showing the closure in a closed position;

FIG. 4 is a cross-sectional view taken along lines 4-4 in FIG. 1;

FIG. 5 is a top plan view of a closure constructed according to a second embodiment of the invention;

FIG. 6 is a top plan view of a closure constructed according to a third embodiment of the invention;

FIG. 7 is a top plan view of the closure constructed according to a fourth embodiment of the invention;

FIG. 8 is a top plan view of a closure constructed according to a fifth embodiment of the invention;

FIG. 9 is a top plan view of a closure constructed according to a sixth embodiment of the invention;

FIG. 10 is a top plan view of a closure constructed according to a seventh embodiment of the invention;

FIG. 11 is a top plan view of a closure constructed according to an eighth embodiment of the invention;

FIG. 12 is a top plan view of a closure constructed according to a ninth embodiment of the invention;

FIG. 13 is a top plan view of a closure constructed according to a tenth embodiment of the invention;

FIG. 14 is a top plan view of a closure constructed according to a eleventh embodiment of the invention; and

FIG. 15 is a top plan view of a closure constructed according to a twelfth embodiment of the invention.

### DETAILED DESCRIPTION OF THE PREFERRED EMBODIMENT(S)

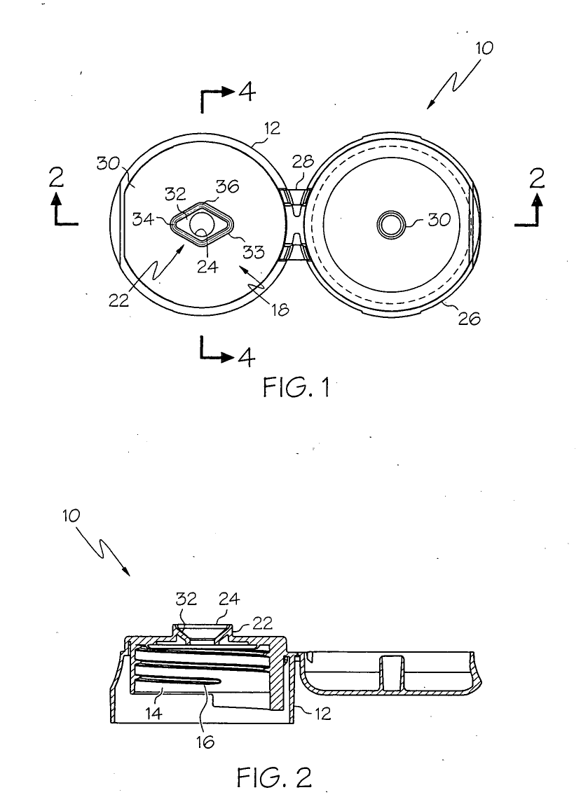

Referring now to the drawings, wherein like reference numerals designate corresponding structure throughout the views, and referring in particular to FIG. 1, a flip top type closure 10 that is constructed according to a preferred embodiment of the invention includes a main body portion 12 that is adapted to be secured to a container. In this preferred embodiment, main body portion 12 includes a downwardly depending internal skirt 14 having internal threading 16 defined thereon, so main body portion 12 may be screwed onto a container.

As is best shown in FIG. 1, main body portion 12 includes an upper deck portion 18 having an upper surface 20 that in the preferred embodiment of the invention is substantially flat and smooth. A dispensing spout 22 extends upwardly from the upper surface 20 and has a dispensing orifice 24 defined therein that preferably is shaped so as to be substantially circular in transverse cross-section. Dispensing spout 22 preferably is elevated at its highest point with respect to the upper surface 20 of the upper deck portion 18 by a distance that is within a range of about 20 percent to about 80 percent of the vertical distance between the upper surface 20 and the underside of a lid member 26 when the lid member 26 is in the closed position.

Dispensing spout 22 is advantageously provided with a noncircular shape when viewed in plan. Dispensing spout 22 preferably has a surface area circumscribed by its outer periphery that is within a range of about 10 percent to about 65 percent of the total surface area of the upper surface 20 of the upper deck portion 18.

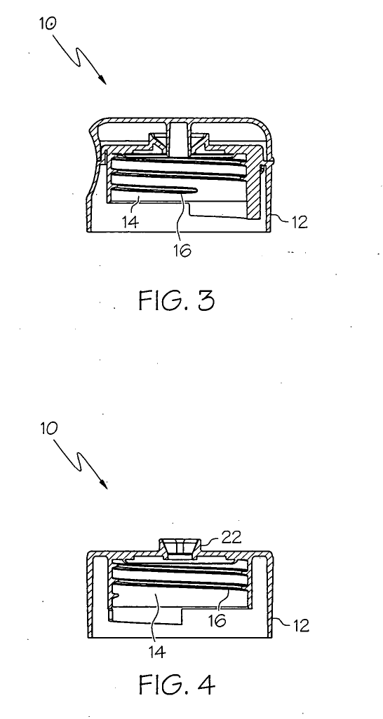

Lid member 26 is hingedly attached to the main body portion 12 by a hinge 28. Preferably, the entire closure 10, including the main body portion 16, lid member 26 and hinge 28 is unitary in structure, being molded out of a single piece of polymeric material such as polyethylene or polypropylene. A downwardly depending plug member 30 extends from an underside of lid member 26 and is sized and shaped to be received within the orifice 24 in order to seal the orifice 24 when the closure 10 is in the closed position, as is illustrated in FIG. 3.

Dispensing spout 22 includes a raised peripheral rim 33 that extends around the periphery of the dispensing spout 22. At least one downwardly sloping surface 32 is defined by the dispensing spout 22 between the raised peripheral rim 33 and orifice 24. In the preferred embodiment, downwardly sloping surface 32 is preferably concave and smooth, and has a varying radius of curvature permitting a smooth, continuously curved transition between the entrance to the orifice 24 and the noncircular outer profile of the raised rim 33 and the outer periphery of the dispensing spout 22. A conical shape is considered to be concave for purposes of this document.

Alternatively, dispensing spout 22 could be provided with a substantially flat upper surface in which the orifice 24 is centrally defined.

In the embodiment of the invention that is shown in FIGS. 1-4, dispensing spout 22 has a diamond shape when viewed in plan as in FIG. 1. As a consequence of this diamond shape, which is oriented in the preferred embodiment so that the long axis of the diamond is parallel with the plane of rotation of the lid member 26 with respect to the main body portion 16 during opening and closing of the closure 10, a pair of primary pouring spouts 34 and secondary pouring spouts 36 are defined at the corners of the diamond shape. Primary and secondary pouring spouts 34, 36 will permit a consumer to more easily control the flow of product from the closure 10 during use. For example, if the product being dispensed is dishwasher detergent, pouring spouts 34, 36 will enable the consumer to precisely control the direction of the dishwasher detergent as it flows from the closure 10.

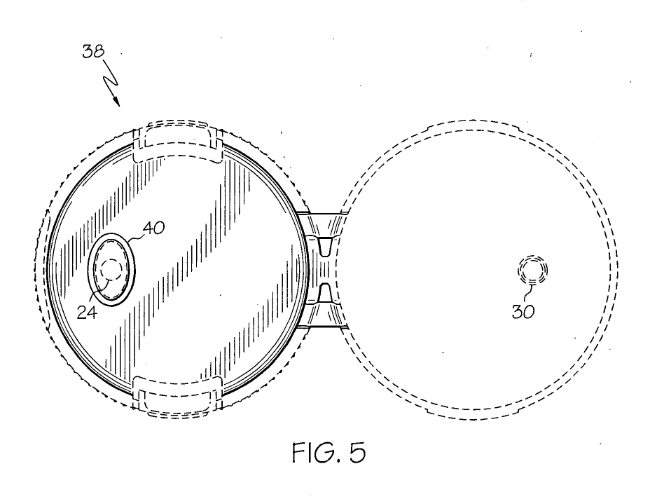

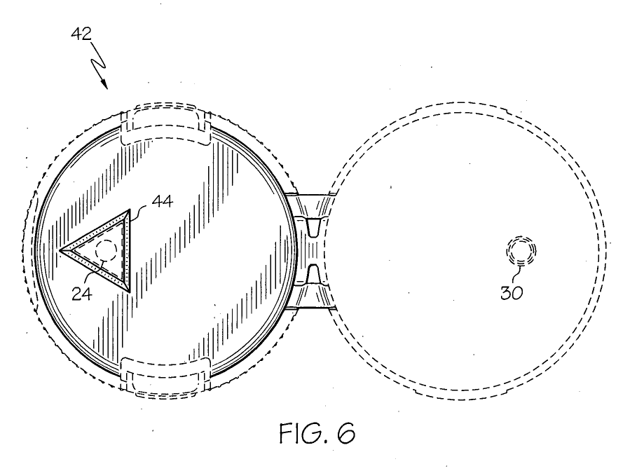

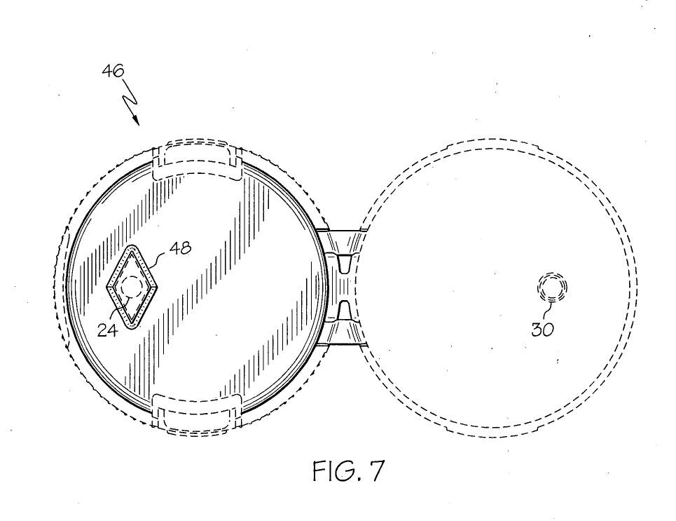

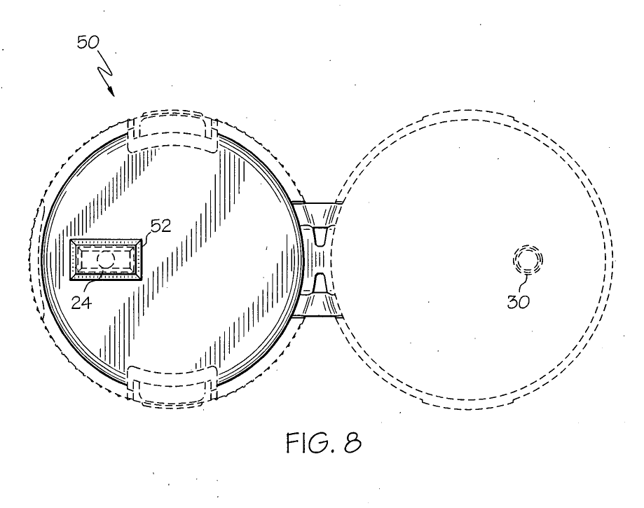

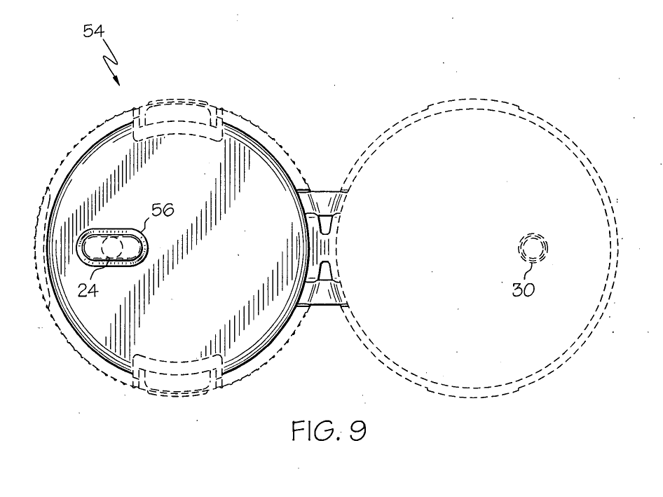

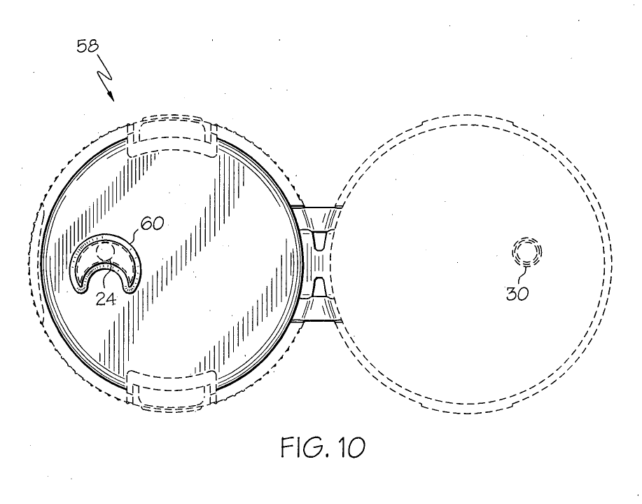

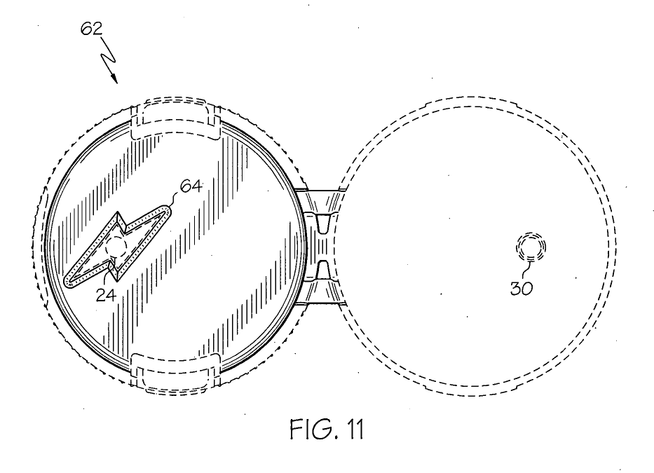

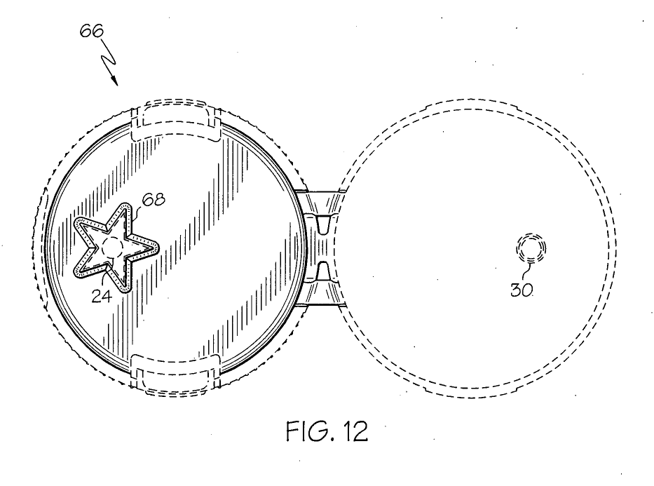

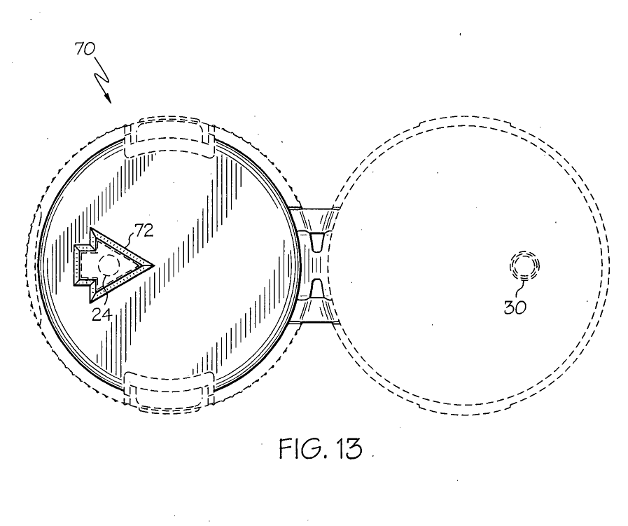

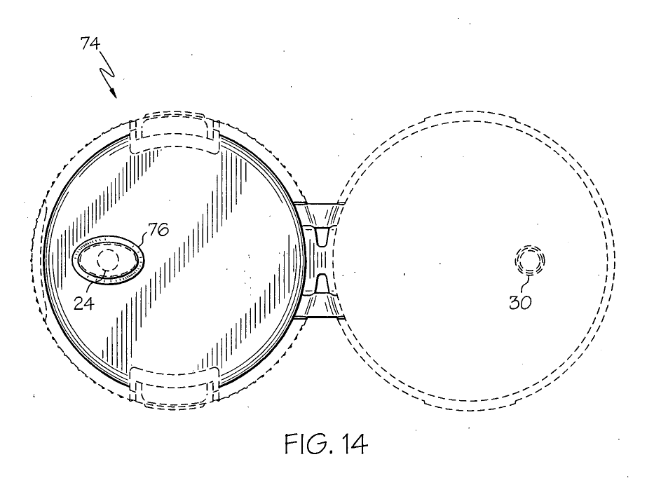

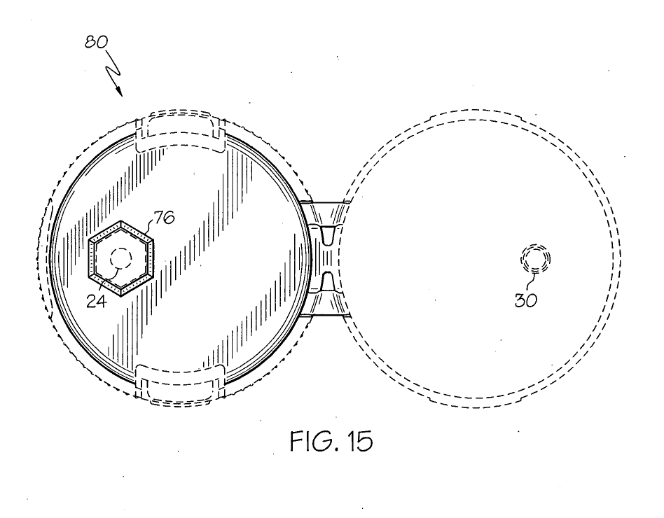

FIG. 5 depicts a closure 38 that is constructed according to a second embodiment of the invention. In this embodiment of the invention, dispensing spout 40 is shaped as an oval. In a third embodiment of the invention that is depicted in FIG. 6 closure 42 is characterized by a dispensing spout 44 that has a triangular shape. In a fourth embodiment of the invention shown in FIG. 7 closure 46 is provided with a diamond shaped dispensing spout 48 that is oriented transversely with respect to the plane of rotation of the lid member 26. In a fifth embodiment of the invention that is illustrated in FIG. 8, closure 50 is characterized by a rectangular shaped dispensing spout 52. In a sixth embodiment of the invention that is shown in FIG. 9 closure 54 is provided with an oblong shaped dispensing spout 56. In a seventh embodiment of the invention that is shown in FIG. 10, closure 58 has a moon shaped dispensing spout 60. In an eighth embodiment of the invention shown in FIG. 11 closure 62 has a dispensing spout 64 that is shaped like a lightning bolt. In a ninth embodiment of the invention that is illustrated in FIG. 12, closure 66 is provided with a star shaped dispensing spout 68. A tenth embodiment of the invention is shown in FIG. 13. In this embodiment, closure 70 is provided with an arrow shaped dispensing spout 72. FIG. 14 depicts an eleventh embodiment of the invention or a closure 74 has an oval shaped dispensing spout 76. FIG. 15 depicts a 12th embodiment of the invention where closure 80 is provided with a hexagonal shaped dispensing spout 76. It is to be understood that these embodiments are exemplary only, and that literally an infinite number of possibilities are present when determining the shape of the dispensing spout according to the invention. Shaping the dispensing spout provides the product manufacturer with a number of possible design advantages and marketing and branding opportunities.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A closure for a container, comprising:
a main body portion that is constructed and arranged to be secured to a container, said main body portion having an upper deck portion defining an upper surface and a dispensing spout projecting upwardly from said upper surface, said main body portion further having a dispensing orifice defined in said dispensing spout, and wherein said dispensing spout is constructed and arranged to have noncircular shape when viewed in plan;
a lid member that is hingedly mounted to said main body portion, said lid member having a plug member that is shaped and sized to selectively plug said dispensing orifice, said lid portion further being movable between a first, open position wherein material may be dispensed from the container through said dispensing orifice and a second, closed position wherein said orifice is blocked by said plug member.

2. A closure for a container according to claim 1, wherein said dispensing orifice is substantially circular in transverse cross-section.

3. A closure for a container according to claim 1, wherein said plug member is substantially circular in transverse cross-section.

4. A closure for a container according to claim 1, wherein said dispensing spout comprises a raised peripheral edge and at least one downwardly sloping surface positioned between said peripheral edge and said dispensing orifice.

5. A closure for a container according to claim 4, wherein said downwardly sloping surface is concave.

6. A closure for a container according to claim 5, wherein said concave downwardly sloping surface has a varying radius of curvature.

7. A closure for a container according to claim 4, wherein said raised peripheral edge includes at least one portion that is shaped so as to define a pouring spout.

8. A closure for a container according to claim 7, wherein said raised peripheral edge includes at least two portions that are shaped so as to define a pouring spout.

9. A closure for a container according to claim 1, wherein said dispensing spout is constructed and arranged to have a diamond shape when viewed in plan.

10. A closure for a container according to claim 1, wherein said dispensing spout is constructed and arranged to have a hexagonal shape when viewed in plan.

11. A closure for a container according to claim 1, wherein said dispensing spout is constructed and arranged to have a triangular shape when viewed in plan.

12. A closure for a container according to claim 1, wherein said dispensing spout is constructed and arranged to have a square shape when viewed in plan.

13. A closure for a container according to claim 1, wherein said dispensing spout is constructed and arranged to have a rectangular shape when viewed in plan.

14. A closure for a container according to claim 1, wherein said dispensing spout is constructed and arranged to have an oblong shape when viewed in plan.

15. A closure for a container according to claim 1, wherein said dispensing spout is constructed and arranged to have moon shape when viewed in plan.

16. A closure for a container according to claim 1, wherein said dispensing spout is constructed and arranged to have lightning bolt shape when viewed in plan.

17. A closure for a container according to claim 1, wherein said dispensing spout is constructed and arranged to have a star shape when viewed in plan.

18. A closure for a container according to claim 1, wherein said dispensing spout is constructed and arranged to have an arrow shape when viewed in plan.

19. A closure for a container according to claim 1, wherein said dispensing spout is constructed and arranged to have an oval shape when viewed in plan.

20. A closure for a container, comprising:
a main body portion that is constructed and arranged to be secured to a container, said main body portion having an upper deck portion defining an upper surface and a dispensing spout projecting upwardly from said upper surface, said main body portion further having a dispensing orifice defined in said dispensing spout, said dispensing spout further having a raised peripheral rim and at least one downwardly sloping surface between said peripheral rim and said dispensing orifice;
a lid member that is hingedly mounted to said main body portion, said lid member having a plug member that is shaped and sized to selectively plug said dispensing orifice, said lid member further being movable between a first, open position wherein material may be dispensed from the container through said dispensing orifice and a second, closed position wherein said orifice is blocked by said plug member.

21. A closure for a container according to claim 20, wherein said downwardly sloping surface is concave.

22. A closure for a container according to claim 21, wherein said concave downwardly sloping surface has a varying radius of curvature.

23. A closure for a container according to claim 20, wherein said raised peripheral edge includes at least one portion that is shaped so as to define a pouring spout.

24. A closure for a container according to claim 23, wherein said raised peripheral edge includes at least two portions that are shaped so as to define a pouring spout.

25. A closure for a container according to claim 20, wherein said dispensing spout has a noncircular shape when viewed in plan.

26. A closure for a container according to claim 25, wherein said dispensing spout is constructed and arranged to have a diamond shape when viewed in plan.

27. A closure for a container according to claim 25, wherein said dispensing spout is constructed and arranged to have a hexagonal shape when viewed in plan.

28. A closure for a container according to claim 25, wherein said dispensing spout is constructed and arranged to have a triangular shape when viewed in plan.

29. A closure for a container according to claim 25, wherein said dispensing spout is constructed and arranged to have a square shape when viewed in plan.

30. A closure for a container according to claim 25, wherein said dispensing spout is constructed and arranged to have a rectangular shape when viewed in plan.

31. A closure for a container according to claim 25, wherein said dispensing spout is constructed and arranged to have an oblong shape when viewed in plan.

32. A closure for a container according to claim 25, wherein said dispensing spout is constructed and arranged to have moon shape when viewed in plan.

33. A closure for a container according to claim 25, wherein said dispensing spout is constructed and arranged to have lightning bolt shape when viewed in plan.

34. A closure for a container according to claim 25, wherein said dispensing spout is constructed and arranged to have a star shape when viewed in plan.

35. A closure for a container according to claim 25, wherein said dispensing spout is constructed and arranged to have an arrow shape when viewed in plan.

36. A closure for a container according to claim 25, wherein said dispensing spout is constructed and arranged to have an oval shape when viewed in plan.
